(19) United States
(12) Patent Application Publication
(10) Pub. No.: US 2025/0018931 A1
(43) Pub. Date: Jan. 16, 2025

(54) SMART PARKING STRATEGY FOR AUTOMATED VEHICLES

(71) Applicant: Valeo Schalter und Sensoren GmbH, Bietigheim-Bissingen (DE)

(72) Inventor: Deep Doshi, Bietigheim-Bissingen (DE)

(73) Assignee: Valeo Schalter und Sensoren GmbH, Bietigheim-Bissingen (DE)

(21) Appl. No.: 18/352,715

(22) Filed: Jul. 14, 2023

(51) Int. Cl. B60W 30/06; B60W 60/00

(52) U.S. Cl. CPC B60W 30/06; B60W 60/007; B60W 2420/403; B60W 2420/54; B60W 2552/00; B60W 2552/10; B60W 2554/4041; B60W 2554/4042; B60W 2554/4044; B60W 2555/60

(57) ABSTRACT

A method for executing an autonomous parking process of a vehicle using a driver assistance system includes sensing an external environment of the vehicle, receiving coordinates identifying a location of the vehicle, receiving a navigational speed limit that is associated with the location identified by the coordinates, and transmitting data associated with the external environment and the navigational speed limit to an Electronic Control Unit of the vehicle. The method further includes carrying out the autonomous parking process of the vehicle, determining a region of interest of the external environment of the vehicle based on the data and the navigational speed limit, and monitoring on-coming traffic within the region of interest.

### BACKGROUND

Parking assistance devices may be employed within a vehicle in order to assist a driver of the vehicle when parking into or exiting a parking space. The parking assistance devices may take over the parking for the driver automatically or be utilized in unmanned vehicles without a driver. This process is referred to as autonomous parking. Specifically, in autonomous parking, the parking assistance device may control the steering, braking, and any gear changes required by the vehicle to park into or exit a parking space.

Parking assistance devices usually use appropriate sensor devices to measure available parking spaces or the current parking space of the vehicle. Accordingly, parking or exiting trajectories are generally calculated on the basis of the parking space geometry determined from the measurement of the parking space and the current position of the vehicle. Further, the parking or exiting trajectory of a vehicle may be corrected during the parking or exiting process, respectively.

In addition, sensor devices of a parking assistance device may detect the presence of objects or obstacles which are located along the parking or exiting trajectory or on a roadway adjoining the parking space. Generally, in the case that the parking assistance device recognizes on-coming traffic on the roadway adjoining the parking space during a parking or exiting maneuver, the parking assistance device aborts the planned maneuver. As a result, the vehicle may continue along the roadway in search for another available parking space or pull back into the current parking space of the vehicle, depending on the maneuver aborted.

### SUMMARY

One or more embodiments of the present invention relate to a method for executing an autonomous parking process of a vehicle using a driver assistance system that includes sensing an external environment of the vehicle, receiving coordinates identifying a location of the vehicle, receiving a navigational speed limit that is associated with the location identified by the coordinates, and transmitting data associated with the external environment and the navigational speed limit to an Electronic Control Unit (ECU) of the vehicle. The method further includes carrying out the autonomous parking process of the vehicle, determining a region of interest of the external environment of the vehicle based on the data and the navigational speed limit, and monitoring on-coming traffic within the region of interest.

One or more embodiments of the present invention relate to a driver assistance system for a vehicle that includes a plurality of detection sensors that collects data associated with an external environment of the vehicle and a navigational sensor that receives coordinates identifying a location of the vehicle and a navigational speed limit that is associated with the location identified by the coordinates. The driver assistance system further includes an ECU that receives data associated with the external environment of the vehicle from the plurality of detection sensors, receives the coordinates and the navigational speed limit from the navigational sensor, and carries out an autonomous parking process of the vehicle. In addition, the ECU determines a region of interest of the external environment of the vehicle based on the data and the navigational speed limit and monitors on-coming traffic within the region of interest detected by the plurality of detection sensors.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 shows a system in accordance with one or more embodiments disclosed herein.

FIGS. 2A-2C show a visualization of a parking-in process in accordance with one or more embodiments disclosed herein.

FIGS. 3A and 3B show a visualization of a parking-in process in accordance with one or more embodiments disclosed herein.

FIGS. 4A-4C show a visualization of a parking-out process in accordance with one or more embodiments disclosed herein.

FIGS. 5A and 5B show a visualization of a parking-out process in accordance with one or more embodiments disclosed herein.

FIGS. 6A-6C show a visualization of a parking-in process in accordance with one or more embodiments disclosed herein.

FIGS. 7A and 7B show a visualization of a parking-in process in accordance with one or more embodiments disclosed herein.

FIGS. 8A-8C show a visualization of a parking-out process in accordance with one or more embodiments disclosed herein.

FIGS. 9A and 9B show a visualization of a parking-out process in accordance with one or more embodiments disclosed herein.

FIG. 10 shows a system in accordance with one or more embodiments disclosed herein.

FIG. 11 shows a flowchart of a method in accordance with one or more embodiments disclosed herein.

FIG. 12 shows a flowchart of a method in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention are directed towards driver assistance systems and methods of operating driver assistance systems. The techniques discussed in this disclosure are beneficial in executing parking-in processes and parking-out processes for automated and autonomous vehicles depending on the movement of traveling vehicles of on-coming traffic. Further, the techniques discussed in this disclosure advantageously reduce the amount of time a vehicle searches for an unoccupied parking spot during a parking-in process and waits in an occupied parking spot during a parking-out process.

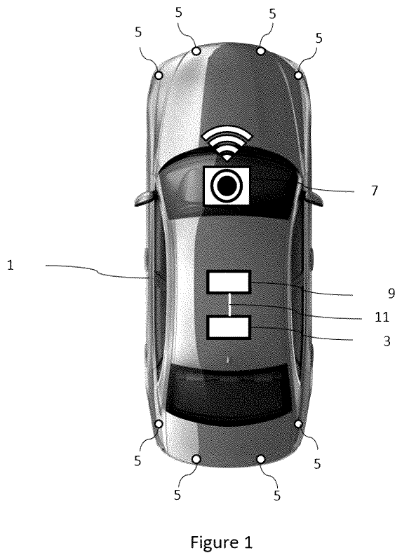

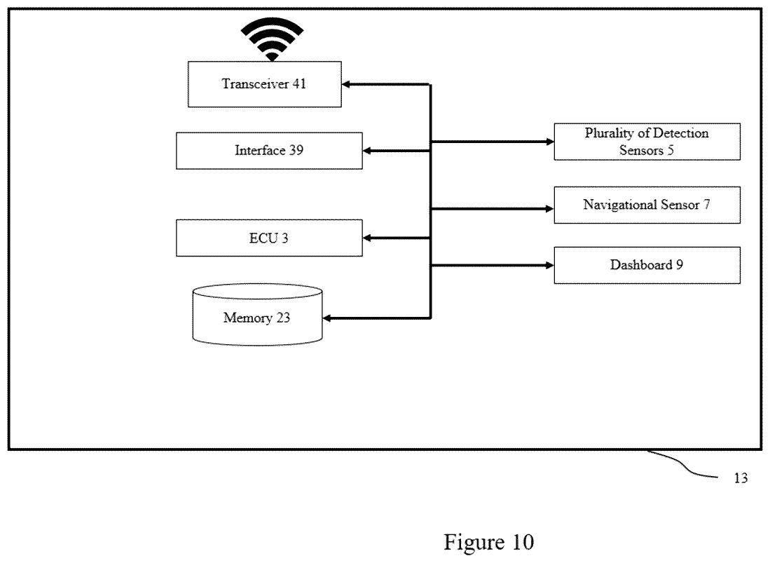

FIG. 1 depicts an example of a vehicle 1 in accordance with one or more embodiments disclosed herein. As shown in FIG. 1, a vehicle 1 includes an Electronic Control Unit (ECU) 3, a plurality of detection sensors 5, and a navigational sensor 7. In addition, the vehicle 1 may further include a dashboard 9. Components of the vehicle 1 are interconnected through the use of a bus 11, which is at least one wire, wiring harness, and/or connector that serve to transmit data throughout the vehicle 1. Collectively, the ECU 3, the plurality of detection sensors 5, the navigational sensor 7, and the bus 11 are part of an Advanced Driver Assistance System (ADAS) 13, which is further discussed in relation to FIG. 10.

The plurality of detection sensors 5 collect quantitative data associated with the external environment of the vehicle 1. At least one detection sensor 5 of the plurality of detection sensors 5 may be a visual sensor. Examples of a detection sensor 5 include a two dimensional camera, a three dimensional or stereoscopic camera, a radar unit, a LiDAR unit, an ultrasonic sensor, or an equivalent sensor or component that perceives the environment of the vehicle 1. Furthermore, the plurality of detection sensors 5 may all be the same type of detection sensor 5 or include a combination of detection sensors 5 that vary in type.

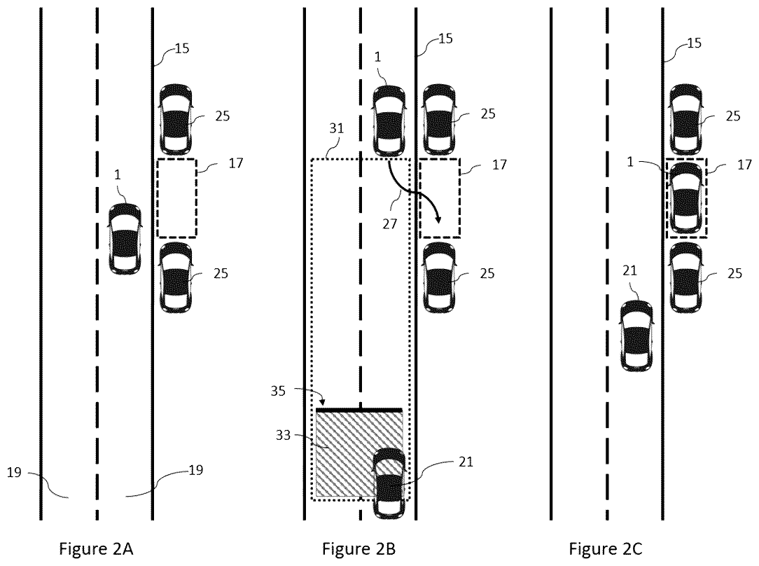

In addition to the plurality of detection sensors 5, the vehicle 1 includes a navigational sensor 7 that receives a signal that includes global coordinates of the vehicle 1. The navigational sensor 7 may be a Global Positioning System (GPS) sensor, for example, or an equivalent sensor that determines the location of the vehicle 1 in relation to the external environment of the vehicle 1. The signal may also include information such as direction and speed of the vehicle 1. In this case, the direction and speed may be derived by comparing the global coordinates to their previous counterparts to determine the length of time that the vehicle 1 was traveling between two points. The signal may further include information associated with the coordinates themselves, such as, for example, which country the coordinates are located in, or a designated speed limit of a roadway 15 (e.g., FIGS. 2A-2C) that the coordinates are located at.

The ECU 3 may be formed of one or more processors, microprocessors, or equivalent computing structures, and serves to assist a user of the vehicle 1 when parking into or exiting a parking space. Accordingly, the ECU 3 may be employed to control the parking for the user automatically or upon request of the user. That is, the ECU 3 may control the steering, braking, and any gear changes required by the vehicle 1 to park into or exit a parking space. In addition, data captured by the plurality of detection sensors 5 is transmitted to and processed by the ECU 3. Further, the ECU 3 receives the navigational speed limit from the navigational sensor 7.

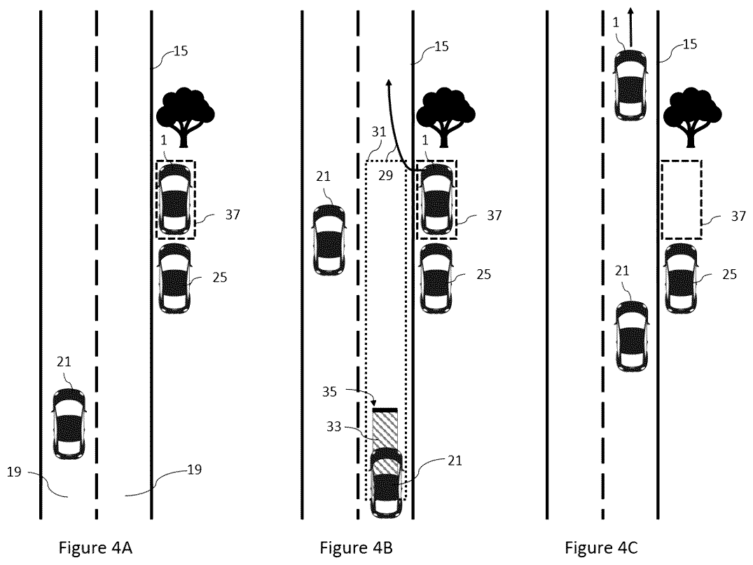

The dashboard 9 of the vehicle 1 is a display such as a Liquid Crystal Display (LCD), an Organic Light-Emitting Diode (OLED) display, a quantum dot display, or equivalent display. As such, the dashboard 9 is configured to present the user with information received from the ECU 3. This information may include identified unoccupied parking spaces, possible parking-in trajectories and parking-out trajectories, a video feed of the external environment of the vehicle 1, and object detection warnings as discussed later in FIGS. 2A-2C and 4A-4C.

FIGS. 2A-2C depict a visualization of a parking-in process in accordance with one or more embodiments disclosed herein. Specifically, in FIG. 2A, a vehicle 1 is traveling on a roadway 15 in search of an unoccupied parking space 17. In this non-limiting example, parking is available parallel to and along the roadway 15, where the roadway 15 includes two lanes 19 for automotives traveling in the same direction. While the vehicle 1 is traveling on the roadway 15, the plurality of detection sensors 5 capture raw data, such as an area map and/or a video feed, that includes markings, objects, and/or obstacles delimiting an unoccupied parking space 17. In addition, the plurality of detection sensors 5 may capture objects on the roadway 15 behind and in front of the vehicle 1 such as other traveling vehicles 21, pedestrians, and animals.

Simultaneously, while capturing the data of the external environment of the vehicle 1, the data is processed to identify unoccupied parking spaces 17 therefrom. An object detection process may be performed by the ECU 3, a dedicated component such as a graphics card, or by the plurality of detection sensors 5 themselves. As an output of the algorithm, the ECU 3 may receive identification of an unoccupied parking space(s) 17, the location of the unoccupied parking space(s) 17, and any text associated with the unoccupied parking space(s) 17, such as labeling associated with the unoccupied parking space(s) 17. Specifically, the ECU 3 may determine if an unoccupied parking space 17 is a “Handicap” or “Employee Only” restricted parking space. Such context of an unoccupied parking space 17 may be determined by the ECU 3 based on context information provided by the plurality of detection sensors 5 and/or by the navigational sensor 7. That is, the ECU 3 and/or the navigational sensor 7 may analyze cloud based map data or GPS coordinates of the vehicle 1 provided by a signal to determine a context associated with an unoccupied parking space 17. The context of an unoccupied parking space 17 may be received from an external server (not shown) or derived from information, such as a map or lookup table, stored in a memory 23 (e.g., FIG. 10) of the vehicle 1.

In addition, a user of the vehicle 1 may identify a location of an unoccupied parking space 17 and instruct the vehicle 1 to autonomously park within this unoccupied parking space 17. The user may actuate a parking-in process into an unoccupied parking space 17 via the dashboard 9.

In FIG. 2A, the plurality of detection sensors 5 has identified an unoccupied parking space 17 along the roadway 15 between two parked vehicles 25. Accordingly, the ECU 3 determines a geometry of the unoccupied parking space 17 from the received data of the plurality of detection sensors 5 and compares the determined geometry of the unoccupied parking space 17 to a geometry of the vehicle 1. If the ECU 3 determines that the unoccupied parking space 17 is of a predetermined suitable size, the ECU 3 may commence a parking-in process.

In FIG. 2B, the ECU 3 determines an optimum parking-in trajectory 27 for the vehicle 1 to travel in order to park within the unoccupied parking space 17 based on the determined geometry of the unoccupied parking space 17, a geometry of the vehicle 1, and a current location of the vehicle 1. The parking-in trajectory 27 may include one or more straight and/or curved maneuvers. Further, the parking-in trajectory 27 may be restricted to a maximum number of straight and/or curved forward maneuvers and/or rearward maneuvers. As such, the ECU 3 may determine whether a parking-in process is at all possible for an associated unoccupied parking space 17. In addition, in the case of a manned vehicle 1, the ECU 3 may present a plurality of parking-in trajectories 27 to the user through the dashboard 9, permitting the user to select a parking-in trajectory 27 different from the optimum parking-in trajectory 27. The plurality of parking-in trajectories 27 may differ in the number and type of maneuvers, as well as an estimated time associated with each parking-in trajectory 27.

The ECU 3 is configured to control the steering, braking, and any gear changes required by the vehicle 1 to carry out a parking-in process and a parking-out process along a parking-in trajectory 27 and a parking-out trajectory 29 (e.g., FIGS. 4A-4C), respectively. Prior to a first maneuver of the vehicle 1 along the parking-in trajectory 27 or the parking-out trajectory 29, or during the parking-in process or the parking-out process, the plurality of detection sensors 5 may detect a traveling vehicle 21 traveling on the roadway 15 towards the vehicle 1. Generally, it is common practice for parking assistance devices to abort the parking-in process or the parking-out process. That is, upon detection of a traveling vehicle 21 or upon the traveling vehicle 21 being a predetermined distance from the vehicle 1, the ECU 3 aborts the parking-in process or the parking-out process forces the vehicle 1 to continue forward along the roadway 15 or to pull back into the current parking space of the vehicle 1, respectively.

Consequently, subsequent to the aborted parking-in process or the aborted parking-out process, the vehicle 1 may be forced to search of another unoccupied parking space 17 near a roadway 15 without on-coming traffic or stuck in the current parking space of the vehicle 1, respectively. Depending on current traffic conditions and location of the roadway 15 of the vehicle 1, the vehicle 1 may search for an unoccupied parking space 17 or be stuck in the current parking space of the vehicle 1 for an extended period of time. As such, a driver assistance system that effectively reduces the waiting time required to perform a parking-in process or a parking-out process of an autonomous vehicle 1 is beneficial. Accordingly, embodiments disclosed herein present methods and systems for executing an autonomous parking process of a vehicle 1 that reduces the waiting time associated with traffic of a roadway 15 of the vehicle 1.

As seen in FIG. 2B, the ECU 3 of the present invention determines a Region of Interest (ROI) 31 of the external environment of the vehicle 1. The ROI 31 is an area of the external environment of the vehicle 1 monitored by the ECU 3 in order to determine the procedure for the vehicle 1 to follow during a parking-in process and a parking-out process. In addition, the user of the vehicle 1 may be notified upon a traveling vehicle 21 entering the ROI 31 via the dashboard 9. The ROI 31 is determined by the ECU 3 based on the data received from the plurality of detection sensors 5 and the navigational speed limit from the navigational sensor 7. Based on the orientation of the non-limiting example of FIG. 2B, the data provided by the plurality of detection sensors 5 determines a width of the ROI 31. The width of the ROI 31 may be the total width of the roadway 15 or the width of the current lane 19 of the roadway 15 that the vehicle 1 is located in. Further, the width of the ROI 31 may be predetermined by the user of the vehicle 1 or dependent on the width of the lanes 19 of the roadway 15 or the associated parking-in trajectory 27 or parking-out trajectory 29. Here, in FIG. 2B, the width of the ROI 31 is depicted as the total width of roadway 15.

Based on the orientation of the non-limiting example of FIG. 2B, a length of the ROI 31 is based on the navigational speed limit provided by the navigational sensor 7. Specifically, the length of the ROI 31 is a function of the maximum navigational speed limit of the roadway 15 of the vehicle 1 and an estimated time to complete the associated parking-in process or the parking-out process. That is, the length of the ROI 31 for a parking-in process or a parking-out process may be determined by the function:

$$ROI = ( Speed Limit ) \times ( Estimated Time ) \qquad ( 1 )$$

For example, if the navigational speed limit of the roadway 15 of the vehicle 1 is 25 Miles Per Hour (MPH) or 11.176 meters per second (m/s), and the estimated time to complete the parking-in process is 10 seconds(s), then the length of the ROI 31 would be approximately 117.760 meters (m).

In one or more embodiments, the ROI 31 may extend from the rear end of the vehicle 1 along the roadway 15 away from the vehicle 1, as depicted in the non-limiting example FIG. 2B. However, the ROI 31 may extend from any point of the vehicle 1 along the roadway 15 behind the vehicle 1. Further, in one or more embodiments, the ROI 31 may extend in a plurality of directions away from the vehicle 1. For example, the ROI 31 may extend behind and in front of the vehicle 1 along the roadway 15 from the center of the vehicle 1.

Further, the ROI 31 includes a safe zone 33. If a traveling vehicle 21 crosses a threshold 35 of the safe zone 33 of the ROI 31 prior to the vehicle 1 finishing a parking-in process or a parking-out process, the ECU 3 performs a cautious maneuver. The threshold 35 of the safe zone 33 is an end of the safe zone 33 closest to the vehicle 1. In the non-limiting example of FIG. 2B, the width of the safe zone 33 is the same as the width of the ROI 31. However, the width of the safe zone 33 may be less than the width of the ROI 31. That is, the width of the safe zone 33 may be merely the width of the current lane 19 of the roadway 15 that the vehicle 1 is located in or predetermined by the user of the vehicle 1. Based on the orientation of the non-limiting example of FIG. 2B, a length of the safe zone 33 is defined as a predetermined percentage of the ROI 31 or a predetermined time within the ROI 31. For example, the safe zone 33 may be predetermined as 25% of the length of the ROI 31. Accordingly, with respect to the previously mentioned example that the ROI 31 is 117.760 m, the length of the safe zone 33 would be 27.940 m. In another example, the safe zone 33 may be predetermined as 2 s within the ROI 31. Therefore, with respect to the previously mentioned example that the ROI 31 is 117.760 m, the length of the safe zone 33 would then be 22.352 m. In the non-limiting example of FIG. 2B, the safe zone 33 extends from the longitudinal end of the ROI 31 farthest from the vehicle 1 towards the vehicle 1.

During a parking-in process into an unoccupied parking space 17, when no traveling vehicles 21 of on-coming traffic are detected within the ROI 31 or the safe zone 33, the vehicle 1 is maneuvered by the ECU 3 along a parking-in trajectory 27 determined by the ECU 3 into the unoccupied parking space 17. In FIG. 2B, a traveling vehicle 21 of on-coming traffic along the roadway 15 has been detected by the plurality of detecting sensors 5 as having entered the safe zone 33 of the ROI 31 while the vehicle 1 is performing a parking-in process along the parking-in trajectory 27 into the unoccupied parking space 17. Since the traveling vehicle 21 is merely located within the safe zone 33 of the ROI 31 but has not crossed the threshold 35 of the safe zone 33, the vehicle 1 continues the parking-in process. In one or more embodiments, the ECU 3 may actuate external warnings of the vehicle 1 subsequent to a traveling vehicle 21 entering the safe zone 33 of the ROI 31. Actuation of external warnings of the vehicle 1 may include actuating hazard warning lights (not shown) of the vehicle 1 and/or sounding the horn (not shown) of the vehicle 1. In addition to actuating external warnings of the vehicle 1. the ECU 3 may also actuate internal warnings within the interior of the vehicle 1 to inform a user of the vehicle 1. Specifically, internal warnings of the vehicle 1 may include audible sounds and haptic feedback for a user of the vehicle 1. In particular, the ECU 3 may inform the user that a traveling vehicle 21 has entered a safe zone 33 of an ROI 31 via a sound system (not shown) of the vehicle 1 and/or one or more components of the steering wheel (not shown) that causes the steering wheel to generate haptic feedback, such as a vibration.

In FIG. 2C, the vehicle 1 is depicted as being parked within the previously unoccupied parking space 17. In addition, the vehicle 1 is depicted as being parked within the previously unoccupied parking space 17 prior to the traveling vehicle 21 reaching the previous location of the vehicle 1 on the roadway 15.

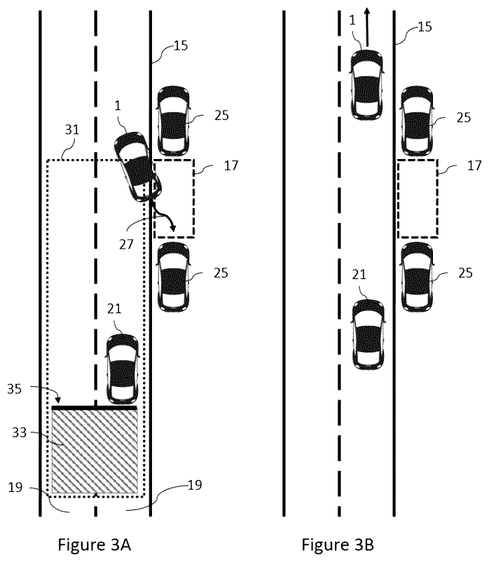

FIGS. 3A and 3B depict a visualization of a parking-in process in accordance with one or more embodiments disclosed herein. Here, in FIG. 3A, a traveling vehicle 21 of on-coming traffic along the roadway 15 has crossed the threshold 35 of the safe zone 33 of the ROI 31 while a vehicle 1 is performing a parking-in process along a parking-in trajectory 27 into an unoccupied parking space 17. In one or more embodiments, if a completion percentage of the parking-in process of the vehicle 1 is greater than a predetermined completion percentage prior to a traveling vehicle 21 crossing the threshold 35 of the safe zone 33, the ECU 3 of the vehicle 1 may actuate external and internal warnings of the vehicle 1. In addition, the ECU 3 may continue the parking-in process of the vehicle 1 at the same or a slower speed. Alternatively, the ECU 3 of the vehicle 1 may perform a cautious maneuver of pausing the parking-in process, thereby stopping the vehicle 1 at the current location of the vehicle 1 along the parking-in trajectory 27. The vehicle 1 may then wait for the traveling vehicle 21 to change lanes 19 of the roadway 15, to travel around the vehicle 1 along the roadway 15, or to also stop in the roadway 15. Subsequently, the vehicle 1 may resume the parking-in process into the unoccupied parking space 17.

In one or more embodiments, if a completion percentage of the parking-in process of the vehicle 1 is less than a predetermined completion percentage subsequent to a traveling vehicle 21 crossing the threshold 35 of the safe zone 33, the ECU 3 of the vehicle 1 may perform a cautious maneuver of aborting the parking-in process. As depicted in FIG. 3B, the ECU 3 may instruct the vehicle 1 to continue along the roadway 15 in search of a different unoccupied parking space 17.

FIGS. 4A-4C depict a visualization of a parking-out process in accordance with one or more embodiments disclosed herein. In particular, FIG. 4A depicts an occupied parking space 37 occupied by a vehicle 1. While the vehicle 1 is turned on and parked along the roadway 15, the plurality of detection sensors 5 capture raw data, such as an area map and/or a video feed, that includes markings, objects, and/or obstacles delimiting the occupied parking space 37. In addition, the plurality of detection sensors 5 may capture objects on the roadway 15 adjoined to the occupied parking space 37, behind and in front of the vehicle 1, such as other traveling vehicles 21, pedestrians, and animals. Here, in FIG. 4A, the plurality of detection sensors 5 has identified that the occupied parking space 37 occupied by the vehicle 1 along the roadway 15 is disposed between a parked vehicle 25 and a tree. Accordingly, the ECU 3 determines a geometry of the occupied parking space 37 from the received data of the plurality of detection sensors 5. In addition, the ECU 3 determines a geometry of the roadway 15 adjoined to the occupied parking space 37 based on the received data from the plurality of detection sensors 5 and/or navigational information of the roadway 15 from the navigational sensor 7.

In FIG. 4B, the ECU 3 determines an optimum parking-out trajectory 29 for the vehicle 1 to travel in order to exit the occupied parking space 37 based on the determined geometry of the occupied parking space 37, the geometry of the vehicle 1, the geometry of the roadway 15 adjoined to the occupied parking space 37, and a current location of the vehicle 1 within the occupied parking space 37. Similar to a parking-in trajectory 27, the parking-out trajectory 29 may include one or more straight and/or curved maneuvers and be restricted to a maximum number of straight and/or curved forward maneuvers and/or rearward maneuvers. As such, the ECU 3 may determine whether a parking-out process is at all possible for an associated occupied parking space 37. In the case of a manned vehicle 1, the ECU 3 may present a plurality of parking-out trajectories 29 to the user through the dashboard 9, permitting the user to select a parking-out trajectory 29 different from the optimum parking-out trajectory 29. The plurality of parking-out trajectories 29 may differ in the number and type of maneuvers, as well as an estimated time associated with each parking-out trajectory 29. In one or more embodiments, the parking-out process may be actuated by the user via the dashboard 9 or automatically by the ECU 3.

Upon actuation of the parking-out process, ECU 3 determines an ROI 31 of the external environment of the vehicle 1 and a safe zone 33. Here, in the non-limiting example of FIG. 4B, the widths of the ROI 31 and the safe zone 33 are depicted as the width of the closest lane 19 of the roadway 15 with respect to the vehicle 1. As stated previously, the length of the ROI 31 may be a function of the maximum navigational speed limit of the roadway 15 and an estimated time to complete the associated parking-in process or the parking-out process. Alternatively, in one or more embodiments, the maximum navigational speed limit of the roadway 15 may be adjusted in order to account for traveling vehicles 21 traveling at speeds greater than the maximum navigational speed limit. In this way, a buffer or a predetermined percentage may be applied to the maximum navigational speed limit of the roadway 15 to account for speeding traveling vehicles 21. That is, the length of the ROI 31 for a parking-in process and a parking-out process may be determined by the function:

$$ROI = ( ( Speed Limit ) \times ( Estimated Time ) ) \div ( Buffer ) \qquad ( 2 )$$

For example, if the speed limit of the roadway 15 of the vehicle 1 is 25 MPH or 11.176 m/s, a buffer of 20% may be applied to the navigational speed limit of the roadway 15. Therefore, the adjusted speed limit would then be 30 MPH or 13.411 m/s. Further, if the estimated time to complete the parking-out process is 5 s, then the length of the ROI 31 would be approximately 67.055 m. The buffer may be determined by the user or by the ECU 3 depending on the context of the roadway 15 adjoining the occupied parking space 37.

When no traveling vehicles 21 of on-coming traffic are detected within the ROI 31 or the safe zone 33 of the ROI 31 during a parking-out process into a roadway 15 adjoining the occupied parking space 37, the vehicle 1 is maneuvered by the ECU 3 along a parking-out trajectory 29 determined by the ECU 3 into the roadway 15. In FIG. 4B, a traveling vehicle 21 of on-coming traffic along the roadway 15 has entered the safe zone 33 of the ROI 31 while the vehicle 1 is performing a parking-out process along the parking-out trajectory 29 into the roadway 15. Since the traveling vehicle 21 has not yet crossed the threshold 35 of the safe zone 33 of the ROI 31, the vehicle 1 continues the parking-out process.

In addition, another traveling vehicle 21 of on-coming traffic is traveling along the roadway 15 in a lane adjacent to the lane 19 of the roadway 15 the vehicle 1 plans to enter. However, since the width of the ROI 31 in the non-limiting example of FIG. 4B is merely the width of the closest lane 19 of the roadway 15 with respect to the vehicle 1. the traveling vehicle 21 in the adjacent lane 19 does not trigger the ECU 3 to perform a cautious maneuver. As such, the vehicle 1 continues the parking-out process. Accordingly, in FIG. 4C, the vehicle 1 is depicted as traveling along the roadway 15 subsequent to a parking-out process.

However, if the traveling vehicle 21 in the adjacent lane 19 travelled into the closest lane 19 of the roadway 15 with respect to the vehicle 1, thereby entering the ROI 31 beyond the threshold 35 of the safe zone 33 of the ROI 31 while the vehicle 1 was performing a parking-out process, the ECU 3 would enact a cautious maneuver, such as pulling back into the occupied parking space 37 in order to avoid collision.

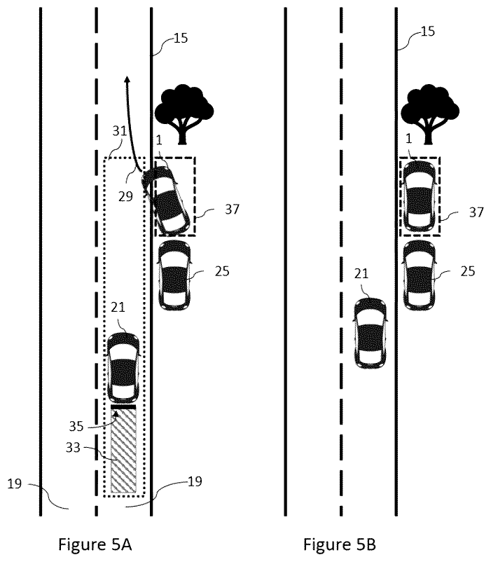

FIGS. 5A and 5B depict a visualization of a parking-out process in accordance with one or more embodiments disclosed herein. Here, in FIG. 5A, a traveling vehicle 21 of on-coming traffic along the roadway 15 has crossed the threshold 35 of the safe zone 33 of the ROI 31 while a vehicle 1 is performing a parking-out process along a parking-out trajectory 29 into the roadway 15 adjoining the occupied parking space 37 occupied by the vehicle 1. Similar to the parking-in process, in one or more embodiments, if a completion percentage of the parking-out process of the vehicle 1 is greater than a predetermined completion percentage prior to a traveling vehicle 21 crossing the threshold 35 of the safe zone 33, the ECU 3 of the vehicle 1 may actuate external and internal warnings of the vehicle 1. In addition, the ECU 3 may continue the parking-out process of the vehicle 1 at the same or a slower speed. Alternatively, the ECU 3 of the vehicle 1 may perform a cautious maneuver of pausing the parking-out process, thereby stopping the vehicle 1 at the current location of the vehicle 1 along the parking-out trajectory 29. The vehicle 1 may then wait for the traveling vehicle 21 to change lanes 19 of the roadway 15, to travel around the vehicle 1 along the roadway 15, or to also stop in the roadway 15. Subsequently, the vehicle 1 may resume the parking-out process exiting the occupied parking space 37.

However, if a completion percentage of the parking-out process of the vehicle 1 is less than a predetermined completion percentage subsequent to a traveling vehicle 21 crossing the threshold 35 of the safe zone 33, the ECU 3 of the vehicle 1 may perform a cautious maneuver of aborting the parking-out process. As depicted in FIG. 5B, the ECU 3 may control the vehicle 1 to pull back into the occupied parking space 37. The ECU 3 may determine a parking-in trajectory 27 and perform a parking-in process in order to pull back into the occupied parking space 37. In addition, once returned to the occupied parking space 37, the vehicle 1 may remain in the occupied parking space 37 until the plurality of detection sensors 5 and the ECU 3 determine that the ROI 31 is clear of on-coming traffic of traveling vehicles 21.

In one or more embodiments, the safe zone 33 may be modified based on the speed and position of traveling vehicles 21 within the ROI 31. Specifically, the ECU 3 may analyze the data provided by the plurality of sensors 5 to determine the speed and position of each traveling vehicle 21 of on-coming traffic within the ROI 31. In some cases, the speed of a traveling vehicle 21 within the ROI 31 may be far greater than the maximum navigational speed limit of the roadway 15. Accordingly, upon detection of a speeding traveling vehicle 21, the ECU 3 may increase the length of the safe zone 33 based on the determined speed of the speeding traveling vehicle 21. In this way, the speeding traveling vehicle 21 will cross a threshold 35 of the modified safe zone 33 sooner than the speeding traveling vehicle 21 would have if the length of the safe zone 33 remained as a predetermined percentage of the ROI 31 or a predetermined time within the ROI 31. As such, the vehicle 1 performing a parking-in process or a parking-out process is granted additional time to actuate the external and internal warnings of the vehicle 1 and to perform a cautious maneuver, thereby potentially preventing a collision between a speeding traveling vehicle 21 and the vehicle 1.

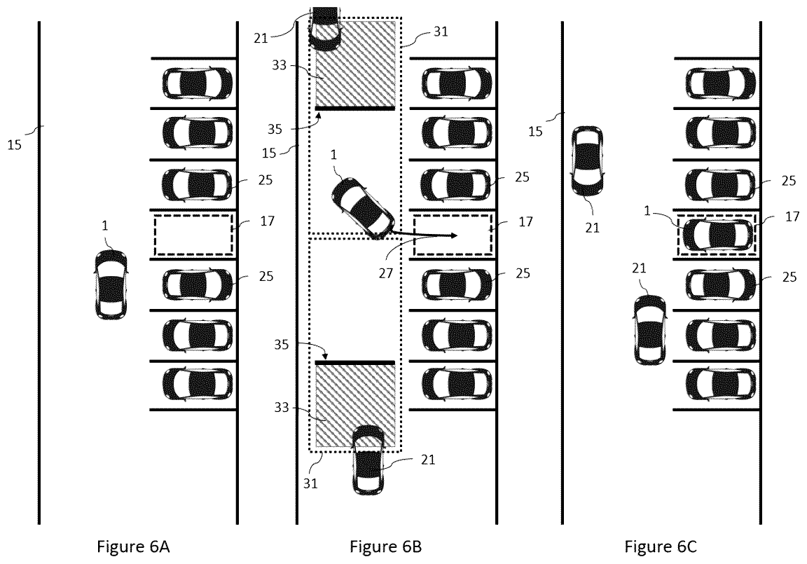

FIGS. 6A-6C depict a visualization of a parking-in process in accordance with one or more embodiments disclosed herein. In FIG. 6A, a vehicle 1 is traveling along a “parking lot” roadway 15 in search of an unoccupied parking space 17. In this non-limiting example, parking is available perpendicular to the roadway 15. As the vehicle 1 travels along the roadway 15, the plurality of detection sensors 5 captures data associated with the external environment of the vehicle 1 and the ECU 3 processes the data in order to identify an unoccupied parking space(s) 17. Subsequent to the ECU 3 or user identifying an unoccupied parking space 17, the parking-in process of the vehicle 1 may be actuated.

In FIG. 6B, the ECU 3 determines an optimum parking-in trajectory 27 for the vehicle 1 to travel in order to park within the unoccupied parking space 17 based on the determined geometry of the unoccupied parking space 17 and a current location of the vehicle 1. In the case that the unoccupied parking space 17 is perpendicular or diagonal to the roadway 15, the parking-in trajectory 27 may utilize forward maneuvers and rearward maneuvers to park the vehicle 1 in a forward-facing orientation within the unoccupied parking space 17. Alternatively, the parking-in trajectory 27 may utilize forward maneuvers and rearward maneuvers to park the vehicle 1 in a rearward-facing orientation within the unoccupied parking space 17. The final orientation of the vehicle 1 within the unoccupied parking space 17 may be predetermined by the user via the dashboard 9 or determined by the ECU 3. That is, the final orientation of the vehicle 1 within the unoccupied parking space 17 may be dependent on an optimum parking-in trajectory 27 that includes the least amount of maneuvers required to complete the associated parking-in process or has the lowest estimated time to complete the associated parking-in process. Here, in the non-limiting FIG. 6B, the optimum parking-in trajectory 27 is depicted as maneuvering the vehicle 1 such that vehicle 1 backs into the unoccupied parking space 17.

Upon actuation of the parking-out process, ECU 3 determines an ROI 31 of the external environment of the vehicle 1 and a safe zone 33. In one or more embodiments, the ROI 31 may include a plurality of safe zones 33. In this way, the ECU 3 may recognize potential hazards in a plurality of directions while completing a parking-in process or a parking-out process. Each safe zone 33 of the ROI 31 may include a threshold 35 which is the boundary of the safe zone 33 nearest to the vehicle 1. Accordingly, if a traveling vehicle 21 of on-coming traffic crosses the threshold 35 of any safe zone 33 of a plurality of safe zones 33 of an ROI 31, the ECU 3 performs a cautious maneuver of the vehicle 1. Further, a safe zone 33 may be disposed at each longitudinal end of the ROI 31.

In one or more embodiments, the ECU 3 may determine a plurality of ROI's 31 as shown in FIG. 6B. Similarly, a plurality of ROI's 31 permits the ECU 3 to recognize potential hazards in a plurality of directions while completing a parking-in process or a parking-out process. Each ROI 31 of the plurality of ROI's 31 may extend in different and/or opposite directions away from the vehicle 1 along the roadway 15 from a same point of the vehicle 1 as shown in FIG. 6B. Alternatively, each ROI 31 of the plurality of ROI's 31 may extend away from the vehicle 1 along the roadway 15 from different points of the vehicle 1. For example, a first ROI 31 may extend in front of the vehicle 1 along the roadway 15 from a front end of the vehicle 1, while a second ROI 31 may extend behind the vehicle 1 along the roadway 15 from a rear end of the vehicle 1. Further, in the case that a plurality of ROI's 31 are determined, each ROI 31 includes a safe zone 33, and each safe zone 33 is positioned at a furthest end of the respective ROI 31 away from the vehicle 1.

Turning back to FIG. 6B, the widths of each ROI 31 of the plurality of ROI's 31 and each safe zone 33 are depicted as the width of the “parking lot” roadway 15 adjoining the unoccupied parking space 17. Alternatively, the widths of each ROI 31 and the safe zone 33 may be larger or smaller depending on a width of the associated roadway 15 or the parking-in trajectory 27.

When no traveling vehicles 21 of on-coming traffic are detected within an ROI 31 or the safe zone 33 of an ROI 31 during a parking-in process into an unoccupied parking space 17, the vehicle 1 is maneuvered by the ECU 3 along a parking-in trajectory 27 determined by the ECU 3 into the unoccupied parking space 17. In FIG. 6B, while the vehicle 1 is performing a parking-in process along the parking-in trajectory 27 into the unoccupied parking space 17, a traveling vehicle 21 of on-coming traffic along the roadway 15 has entered the safe zone 33 of the ROI 31 behind the vehicle 1 and a traveling vehicle 21 of on-coming traffic along the roadway 15 has entered the safe zone 33 of the ROI 31 in front of the vehicle 1. Since neither of the traveling vehicles 21 have crossed the threshold 35 of the respective safe zones 33 of the plurality of ROI's 31, the vehicle 1 continues the parking-in process. Accordingly, in FIG. 6C, the vehicle 1 is depicted as being parked within the previously unoccupied parking space 17 subsequent to a parking-in process.

In one or more embodiments, the ECU 3 may monitor distances between the vehicle 1 and detected markings, objects, and/or obstacles delimiting the unoccupied parking space 17 and the adjoining roadway 15 measured by the plurality of detection sensors 5 during a parking-in process. In this way, the parking-in trajectory 27 of the vehicle 1 determined by the ECU 3 may be dynamically adjusted or corrected during the parking-in process as the geometries of the unoccupied parking space 17 and the adjoining roadway 15 are further measured.

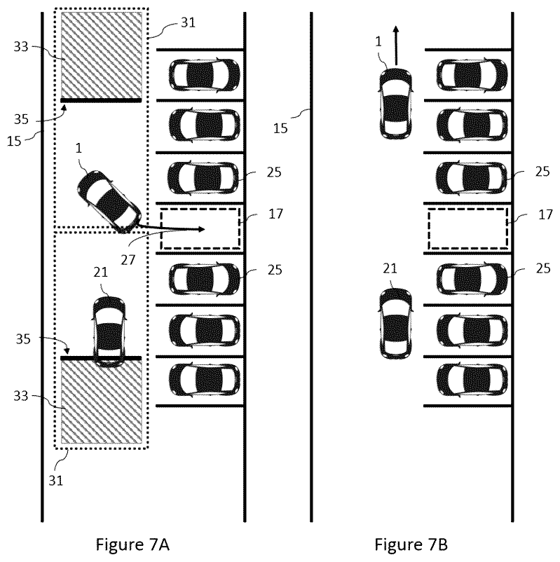

FIGS. 7A and 7B depict a visualization of a parking-in process in accordance with one or more embodiments disclosed herein. Here, in FIG. 7A, a traveling vehicle 21 of on-coming traffic along the roadway 15 has crossed a threshold 35 of a safe zone 33 of a plurality of ROI's 31 of the vehicle 1 while the vehicle 1 is performing a parking-in process along a parking-in trajectory 27 into an unoccupied parking space 17. As discussed previously, in one or more embodiments, if a completion percentage of the parking-in process of the vehicle 1 is greater than a predetermined completion percentage prior to a traveling vehicle 21 crossing the threshold 35 of the safe zone 33, the ECU 3 of the vehicle 1 may actuate external and internal warnings of the vehicle 1. In addition, the ECU 3 may continue the parking-in process of the vehicle 1 at the same or a slower speed. Alternatively, the ECU 3 of the vehicle 1 may perform the cautious maneuver of pausing the parking-in process, thereby stopping the vehicle 1 at the current location of the vehicle 1 along the parking-in trajectory 27. The vehicle 1 may then wait for the traveling vehicle 21 to travel around the vehicle 1 along the roadway 15 or to also stop in the roadway 15. Subsequently, the vehicle 1 may resume the parking-in process into the unoccupied parking space 17.

In one or more embodiments, if the completion percentage of the parking-in process of the vehicle 1 is less than a predetermined completion percentage subsequent to a traveling vehicle 21 crossing the threshold 35 of the safe zone 33, the ECU 3 of the vehicle 1 may perform the cautious maneuver of aborting the parking-out process. As depicted in FIG. 7B, the ECU 3 may instruct the vehicle 1 to continue along the roadway 15 in search of a different unoccupied parking space 17.

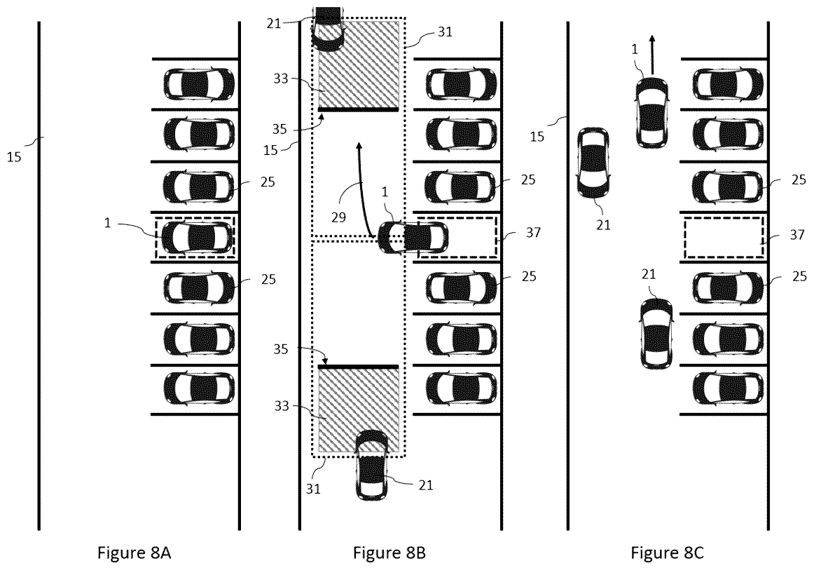

FIGS. 8A-8C depict a visualization of a parking-out process in accordance with one or more embodiments disclosed herein. In particular, FIG. 8A depicts an occupied parking space 37 occupied by a vehicle 1. Here, the plurality of detection sensors 5 has identified that the occupied parking space 37 occupied by the vehicle 1 is adjoined to a “parking lot” roadway 15 and disposed between two parked vehicles 25. Accordingly, the ECU 3 determines a geometry of the occupied parking space 37 and a geometry of the roadway 15 adjoined to the occupied parking space 37 based on the received data from the plurality of detection sensors 5 and/or navigational information of the roadway 15 from the navigational sensor 7.

In FIG. 8B, the ECU 3 determines an optimum parking-out trajectory 29 for the vehicle 1 to travel in order to exit the occupied parking space 37 based on the determined geometry of the occupied parking space 37, the geometry of the vehicle 1, the geometry of the roadway 15 adjoined to the occupied parking space 37, and a current location of the vehicle 1 within the occupied parking space 37. In this non-limiting example, upon actuation of the parking-out process, ECU 3 determines a plurality of ROI's 31 of the external environment of the vehicle 1 and a safe zone 33 for each ROI 31. Specifically, the ECU 3 has determined a first ROI 31 in the roadway 15 with respect to the left-hand side of the vehicle 1 and a second ROI 31 in the roadway 15 with respect to the right-hand side of the vehicle 1 according to the current orientation of the vehicle 1 within the occupied parking space 37.

While the vehicle 1 is performing a parking-out process along the parking-out trajectory 29 into the occupied parking space 37 occupied by the vehicle 1, a traveling vehicle 21 of on-coming traffic along the roadway 15 has entered the safe zone 33 of the first ROI 31 and a traveling vehicle 21 of on-coming traffic along the roadway 15 has entered the safe zone 33 of the second ROI 31. Since neither of the traveling vehicles 21 have crossed the threshold 35 of either safe zone 33 of the plurality of ROI's 31, the vehicle 1 continues the parking-out process. As such, FIG. 8C depicts the vehicle 1 traveling along the roadway 15 subsequent to a parking-out process.

Similar to one or more embodiments of the parking-in process, the ECU 3 may monitor distances between the vehicle 1 and detected markings, objects, and/or obstacles delimiting the occupied parking space 37 and the adjoining roadway 15 measured by the plurality of detection sensors 5 during a parking-out process. In this way, the parking-out trajectory 29 of the vehicle 1 determined by the ECU 3 may be dynamically adjusted or corrected during the parking-out process as the geometries of the occupied parking space 37 and the adjoining roadway 15 are further measured.

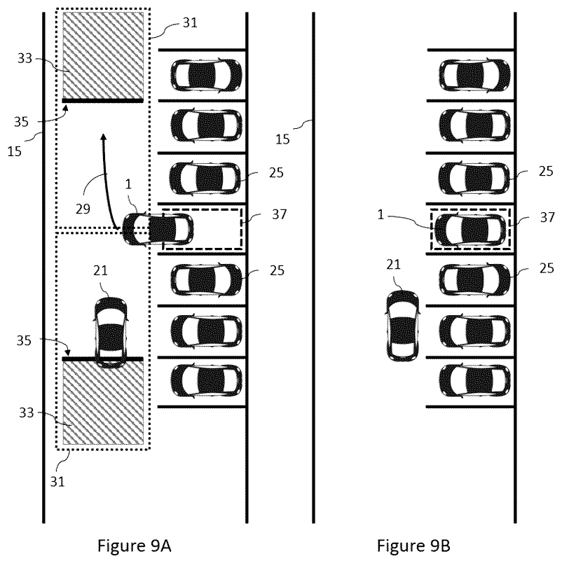

FIGS. 9A and 9B depict a visualization of a parking-out process in accordance with one or more embodiments disclosed herein. Specifically, in FIG. 9A, a traveling vehicle 21 of on-coming traffic along the roadway 15 has crossed a threshold 35 of a safe zone 33 of the first ROI 31 while the vehicle 1 is performing a parking-out process along a parking-out trajectory 29 into the roadway 15 adjoining the occupied parking space 37 occupied by the vehicle 1. In one or more embodiments, if a completion percentage of the parking-in process of the vehicle 1 is greater than a predetermined completion percentage prior to a traveling vehicle 21 crossing the threshold 35 of the safe zone 33, the ECU 3 of the vehicle 1 may actuate the external and internal warnings of the vehicle 1. In addition, the ECU 3 may continue the parking-out process of the vehicle 1 at the same or a slower speed. Alternatively, the ECU 3 of the vehicle 1 may perform the cautious maneuver of pausing the parking-out process, thereby stopping the vehicle 1 at the current location of the vehicle 1 along the parking-in trajectory 27. The vehicle 1 may then wait for the traveling vehicle 21 to travel around the vehicle 1 along the roadway 15 or to also stop in the roadway 15. Subsequently, the vehicle 1 may resume the parking-out process.

However, if a completion percentage of the parking-out process of the vehicle 1 is less than a predetermined completion percentage subsequent to a traveling vehicle 21 crossing the threshold 35 of the safe zone 33 of a ROI 31 of a plurality of ROI's 31, the ECU 3 of the vehicle 1 may perform a cautious maneuver of aborting the parking-out process. As depicted in FIG. 9B, the ECU 3 may control the vehicle 1 to pull back into the occupied parking space 37. Subsequent to the vehicle 1 returning to the occupied parking space 37, the vehicle 1 may remain in the occupied parking space 37 until the plurality of detection sensors 5 and the ECU 3 determine that each ROI 31 of the plurality of ROI's 31 is clear of on-coming traffic of traveling vehicles 21.

One of ordinary skill in the art will appreciate that there are numerous objects that may be present within an ROI 31 beyond a threshold 35 of a safe zone 33 that may cause the ECU 3 to perform a cautious maneuver. For example, the ECU 3 may perform a cautious maneuver during a parking-in process and a parking-out process in order to a prevent collision if the plurality of detection sensors 5 detect a pedestrian or animal in the roadway 15 beyond the threshold 35 of a safe zone 33.

FIG. 10 depicts a system overview of an Advanced Driver Assistance System (ADAS) 13 in accordance with one or more embodiments of the invention. The vehicle 1 includes a plurality of detection sensors 5 which may be optical sensors such as cameras, radar units, LiDAR units, ultrasonic sensors, or other equivalent sensors known to a person of ordinary skill in the art. Additionally, the vehicle 1 includes a navigational sensor 7 which may be a GPS sensor. The navigational sensor 7 is configured to receive coordinates indicating the position of the vehicle 1 and, in one or more embodiments, the navigational speed limit at the location of the coordinates, which is used to calculate the length of an ROI 31 and an associated safe zone 33. The location of the vehicle 1 may be determined by the navigational sensor 7 using satellite-based triangulation or trilateration, for example, and the navigational sensor 7 may be connected to a database, server, stored memory 23, or network to receive navigational speed limits, as is commonly known in the art. Alternatively, the navigational speed limit may be received from an external database or server, for example, or derived from information stored in the vehicle 1 itself.

As described above, the plurality of detection sensors 5 transmits captured data of the external environment of the vehicle 1 to the ECU 3, which is a processor, microprocessor, or circuit that performs processing of the various data described herein. Data is transmitted to the ECU 3 by way of a bus 11, which is wires, wiring harnesses, circuit boards, or equivalent means to interconnect the various components of the vehicle 1. The ECU 3 processes the data using algorithms and processes to extract context information such as the location of the vehicle 1, context signs, obstacles, warning information, guidance information, and regulatory information from the captured data.

After capturing the data, the plurality of detection sensors 5 transmits the captured data to a memory 23. The memory 23 is a non-transitory storage medium such as flash memory, Random Access Memory (RAM), a Hard Disk Drive (HDD), a solid state drive (SSD), a combination thereof, or equivalent. In addition to storing the captured data, the memory 23 also stores processes and/or algorithms that facilitate analyzing captured data, information of the vehicle 1, processes for sending and receiving information to a user (via a dashboard 9, for example), and other functions and processes described herein. Furthermore, the memory 23 stores the GPS coordinates and other forms of data described herein.

The ADAS 13 further includes an interface 39 and a dashboard 9 in order to transmit information to a user of the vehicle 1. The dashboard 9 may be a Liquid Crystal Display (LCD), Organic Light-Emitting Diode (OLED), or equivalent display, while the interface 39 may be one or more buttons, dials, or a touchscreen that allows a user to interact with the vehicle 1. The dashboard 9 displays information such as parking-in trajectories 27 and parking-out trajectories 29 to a user, which allows the user to see and/or select the maneuvers taken by the vehicle 1 in order to complete a parking-in process or a parking-out process, respectively. On the other hand, the interface 39 allows a user to select convenience features such as a unit for measuring the speed limit (such as MPH or Kilometers Per Hour (KPH)). The interface 39 may also be used to allow the user to manually identify and/or select an unoccupied parking space 17 for a parking-in process.

In order to provide further usability and ease of access to a user of the driver assistant system, the ADAS 13 includes a transceiver 41, which wirelessly transmits and receives signals to and from the vehicle 1. Example embodiments of the transceiver 41 include an antenna (not shown) and processor (not shown) that transmit and receive radar, radio, cellular, satellite, Wi-Fi, Bluetooth, Wi-Max, or other equivalent signals. The transceiver 41 may be used to receive navigational data regarding a current or upcoming roadway 15. Further, the transceiver 41 may transmit data about the current roadway 15, unoccupied parking spaces 17, and occupied parking spaces 37 to a server or other nearby traveling vehicles 21. This data may include data captured by the plurality of detection sensors 5 such as objects detected or the geometries of the roadway 15, unoccupied parking spaces 17, and occupied parking spaces 37.

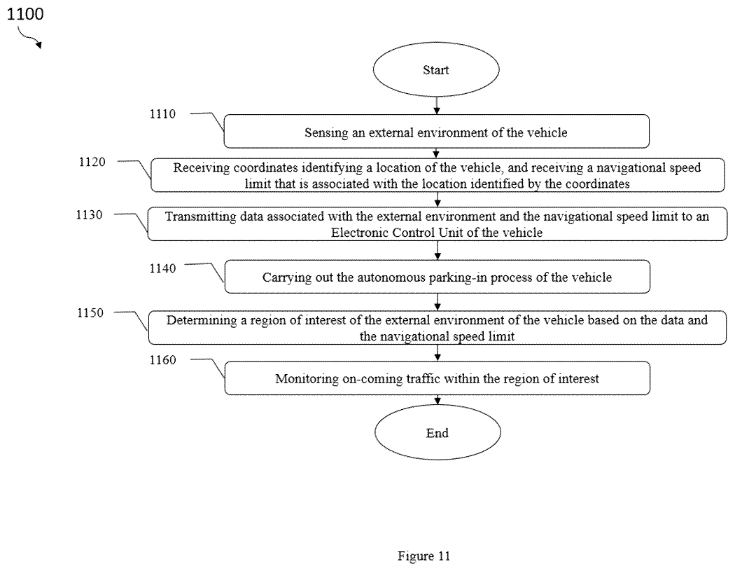

FIG. 11 depicts a flowchart 1100 of a method for executing an autonomous parking-in process of a vehicle 1 in accordance with one or more embodiments disclosed herein. Steps of the flowchart shown in FIG. 11 may be performed by an ADAS 13 as described herein but are not limited thereto. The constituent steps of the method depicted in FIG. 11 may be performed in any logical order, and the method is not limited to the sequence presented.

As depicted in FIG. 11, the method initiates at step 1110, which includes capturing data of an external environment of a vehicle 1. The data of the external environment of the vehicle 1 may be captured while the vehicle 1 is stationary or mobile, and is captured with by a plurality of detection sensors 5 of the vehicle 1. The plurality of detection sensors 5 of the vehicle 1 may be positioned along the front end, rear end, and/or sides of the vehicle 1. Further, data collected by the plurality of detection sensors 5 may include several different views of a roadway 15 the vehicle 1 is located upon, as well as obstacles, signs, and other landmarks in the vicinity of the vehicle 1.

In step 1120, the vehicle 1 receives GPS coordinates and a navigational speed limit at the location identified by the GPS coordinates from a signal. In particular, an ADAS 13 of a vehicle 1 includes a navigational sensor 7, which connects to a satellite network to receive the GPS coordinates. The position of the vehicle 1 may be derived through a triangulation or trilateration procedure, while the navigational speed limit may be received from an external source (such as a server) or a stored database, such as a data annotated map.

In step 1130, the ECU 3 receives the data of the external environment of the vehicle 1 from the plurality of detection sensors 5, as well as the current location coordinates of the vehicle 1 and the associated navigational speed limit from the navigational sensor 7. As discussed above, the ECU 3 is connected to the plurality of detection sensors 5 and the navigational sensor 7 via a bus 11. Thus, step 1130 includes transmitting the data from the plurality of detection sensors 5 and the navigational information from navigational sensor 7 via the bus 11 to the ECU 3.

Subsequently, the data of the external environment of the vehicle 1 is analyzed by the ECU 3 to identify and locate an unoccupied parking space(s) 17 along the current roadway 15 the vehicle 1 is traveling upon. The data of the external environment may be processed through an object detection algorithm. The object detection process may be performed by the ECU 3, a dedicated component such as a graphics card, or by the plurality of detection sensors 5 themselves. Once an unoccupied parking space(s) 17 is identified from the data provided by the plurality of detection sensors 5, the method proceeds to step 1140.

Further, during the process of identifying an unoccupied parking space(s) 17, ECU 3 determines a geometry of the unoccupied parking space(s) 17 from the received data of the external environment of the vehicle 1 from the plurality of detection sensors 5. Accordingly, the determined geometry of the unoccupied parking space(s) 17 is compared to a geometry of the vehicle 1. If the ECU 3 determines that the unoccupied parking space(s) 17 is of a predetermined suitable size, the ECU 3 may actuate a parking-in process.

In addition, in one or more embodiments, the ECU 3 or the navigational sensor 7 may determine a context associated with the unoccupied parking space 17 based on context information provided within the data of the external environment and/or the navigational information supplied to the vehicle 1 by the signal. Specifically, the ECU 3 and/or navigational sensor 7 may determine if the unoccupied parking space 17 includes a restriction assigned to the unoccupied parking space 17. As such, the ECU 3 and/or the navigational sensor 7 may analyze cloud based map data or GPS coordinates of the vehicle 1 provided by a signal to determine a context associated with an unoccupied parking space 17. The context of an unoccupied parking space 17 may be received from an external server (not shown) or derived from information, such as a map or lookup table, stored in a memory 23 of the vehicle 1.

In step 1140, a parking-in process of the vehicle 1 is actuated and carried out. Subsequent to the ECU 3 identifying an unoccupied parking space(s) 17, the ECU 3 may instruct the vehicle 1 to autonomously park within this unoccupied parking space 17. Alternatively, the parking-in process may be actuated by a user of the via the dashboard 9. Upon actuation of a parking-in process, the ECU 3 determines a plurality of possible parking-in trajectories 27 for the vehicle 1 to travel in order to park the vehicle 1 within the unoccupied parking space 17 based on the determined geometry of the unoccupied parking space 17, the geometry of the vehicle 1, and a current location of the vehicle 1.

As such, the ECU 3 may determine whether a parking-in process is at all possible for an associated unoccupied parking space 17. If the ECU 3 determines that a parking-in process is not possible for the associated unoccupied parking space 17, the vehicle 1 may be instructed to continue along the roadway 15 in search of a different unoccupied parking space(s) 17. In the case that the ECU 3 determines the parking-in process is possible within the associated unoccupied parking space 17, the ECU 3 may present the plurality of parking-in trajectories 27 to the user through the dashboard 9, permitting the user to select a parking-in trajectory 27. Alternatively, the ECU 3 may determine an optimum parking-in trajectory 27 of the plurality of parking-in trajectories 27 and automatically instruct the vehicle 1 to follow the optimum parking-in trajectory 27 in order to park within the unoccupied parking space 17.

In step 1150, the ECU 3 determines an ROI 31 of the external environment of the vehicle 1 and a safe zone 33. The width of the ROI 31 and the safe zone 33 may be predetermined or determined based on the geometry of the associated roadway 15 or the parking-in trajectory 27. Further, during a parking-in process, the length of the ROI 31 is a function of the maximum navigational speed limit of the roadway 15 provided by the navigational sensor 7 and an estimated time to complete the associated parking-in process determined by the ECU 3. In one or more embodiments, the maximum navigational speed limit of the roadway 15 may be adjusted in order to account for traveling vehicles 21 traveling at speeds greater than the maximum navigational speed limit. In this way, a buffer may be applied to the maximum navigational speed limit of the roadway 15 to account for speeding traveling vehicles 21. Further, in one or more embodiments, the ECU 3 may determine a plurality of ROI's 31, and each ROI 31 may include a plurality of safe zones 33.

In step 1160, the ECU 3 monitors on-coming traffic within an ROI 31 of the vehicle 1 prior to the vehicle 1 traveling along the parking-in trajectory 27 and while the vehicle 1 travels along the parking-in trajectory 27. In the case that no traveling vehicles 21 of on-coming traffic are detected within the ROI 31 or the safe zone 33 of the ROI 31 during the parking-in process, the vehicle 1 is maneuvered by the ECU 3 along the parking-in trajectory 27. The ECU 3 may control the steering, braking, and any gear changes required by the vehicle 1 to carry out the parking-in process along the parking-in trajectory 27. In the case that a traveling vehicle 21 of on-coming traffic along the roadway 15 has entered the safe zone 33 of an ROI 31 of the vehicle 1 while the vehicle 1 is performing a parking-in process along the parking-in trajectory 27 into the unoccupied parking space 17, but the traveling vehicle 21 has not crossed a threshold 35 of the safe zone 33, the vehicle 1 continues the parking-in process.

Thus, the method completes with the vehicle 1 being parked in the previously unoccupied parking space 17. Alternatively, in a case that a traveling vehicle 21 of on-coming traffic along the roadway 15 has crossed the threshold 35 of the safe zone 33 of the ROI 31 while a vehicle 1 is performing a parking-in process, the ECU 3 may determine the course of action based on a completion percentage of the parking-in process when the traveling vehicle 21 crossed the threshold 35 of the safe zone 33. If a completion percentage of the parking-in process of the vehicle 1 is greater than a predetermined completion percentage prior to a traveling vehicle 21 crossing the threshold 35 of the safe zone 33, the ECU 3 of the vehicle 1 may continue or pause the parking-in process. That is, the ECU 3 may actuate the external and internal warnings of the vehicle 1 while continuing the parking-in process of the vehicle 1 at the same or a slower speed. Alternatively, the ECU 3 of the vehicle 1 may actuate the external and internal warnings of the vehicle 1 while pausing the parking-in process, thereby stopping the vehicle 1 at the current location of the vehicle 1 along the parking-in trajectory 27. The vehicle 1 may then wait for the traveling vehicle 21 to change lanes 19 of the roadway 15, to travel around the vehicle 1 along the roadway 15, or to also stop in the roadway 15. Subsequently, the vehicle 1 may resume the parking-in process into the unoccupied parking space 17.

In contrast, if a completion percentage of the parking-in process of the vehicle 1 is less than a predetermined completion percentage subsequent to a traveling vehicle 21 crossing the threshold 35 of the safe zone 33, the ECU 3 of the vehicle 1 may abort the parking-in process. Specifically, the ECU 3 may control the vehicle 1 to continue along the roadway 15 in search of a different unoccupied parking space 17, and the method may restart at step 1110.

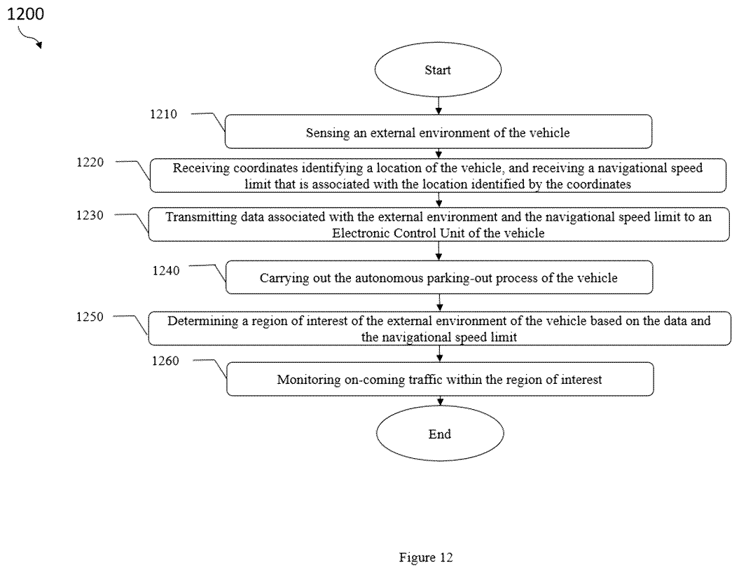

FIG. 12 depicts a flowchart 1200 of a method for executing an autonomous parking-out process of a vehicle 1 in accordance with one or more embodiments disclosed herein. Steps of the flowchart shown in FIG. 12 may be performed by an ADAS 13 as described herein but are not limited thereto. The constituent steps of the method depicted in FIG. 12 may be performed in any logical order, and the method is not limited to the sequence presented.

In step 1210, data of the external environment of the vehicle 1 is captured by a plurality of detection sensors 5 of the vehicle 1 while the vehicle 1 is stationary within an occupied parking space 37. The plurality of detection sensors 5 of the vehicle 1 may be positioned along the front end, rear end, and/or sides of the vehicle 1. Further, the plurality of detection sensors 5 may capture obstacles, signs, and other landmarks in the vicinity of the vehicle 1 and several different views of a roadway 15 adjoined to the occupied parking space 37 occupied by the vehicle 1.

In step 1220, the vehicle 1 receives GPS coordinates from a signal of a current location of the vehicle 1 within the occupied parking space 37. Based on the location of the vehicle 1, the vehicle 1 also receives a navigational speed limit associated with a roadway 15 adjoined to the occupied parking space 37. The navigational speed limit may be received from an external source (such as a server) or a stored database, such as a data annotated map.

In step 1230, the data of the external environment of the vehicle 1, the current location coordinates of the vehicle 1, and the associated navigational speed limit are transmitted to the ECU 3. Structurally, the plurality of detection sensors 5 and the navigational sensor 7 are connected to the ECU 3 via a bus 11. The ECU 3 may send signals requesting the data of the external environment, GPS coordinates, and navigational speed limits to the plurality of detection sensors 5 and the navigational sensor 7. Alternatively, the plurality of detection sensors 5 and the navigational sensor 7 may transmit the data and navigational information, respectively, at routine intervals according to the speed of the vehicle 1, a predetermined transmission rate, or at a request of a user without departing from the nature of this specification.

Subsequently, the ECU 3 analyzes the data of the external environment of the vehicle 1 to determine a geometry of the occupied parking space 37. In addition, the ECU 3 determines a geometry of the roadway 15 adjoined to the occupied parking space 37 based on the received data from the plurality of detection sensors 5 and/or navigational information of the roadway 15 from the navigational sensor 7. The data of the external environment may be processed through an object detection algorithm. The object detection process may be performed by the ECU 3, a dedicated component such as a graphics card, or by the plurality of detection sensors 5 themselves.

In step 1240, a parking-out process of the vehicle 1 is actuated and carried out. The parking-out process may be actuated by a user of the via the dashboard 9 or automatically by the ECU 3. Upon actuation of a parking-out process, the ECU 3 determines a plurality of possible parking-out trajectories 29 and/or an optimum parking-out trajectory 29 for the vehicle 1 to travel in order to exit the occupied parking space 37 occupied by the vehicle 1 based on the determined geometry of the occupied parking space 37, the geometry of the vehicle 1, the geometry of the roadway 15 adjoined to the occupied parking space 37, and a current location of the vehicle 1 within the occupied parking space 37.

In step 1250, the ECU 3 determines an ROI 31 of the external environment of the vehicle 1 and a safe zone 33. The width of the ROI 31 and the safe zone 33 may be predetermined or determined based on the geometry of the adjoined roadway 15 or the parking-out trajectory 29. The length of the ROI 31 is a function of the maximum navigational speed limit of the roadway 15 provided by the navigational sensor 7 and an estimated time to complete the associated parking-out process. In one or more embodiments, the ECU 3 may determine a plurality of ROI's 31. Further, in one or more embodiments, each ROI 31 may include a plurality of safe zones 33.

In step 1260, the ECU 3 monitors on-coming traffic along the adjoined roadway 15 within an ROI 31 of the vehicle 1 prior to the vehicle 1 traveling along the parking-out trajectory 29 and while the vehicle 1 travels along the parking-out trajectory 29. In the case that no traveling vehicles 21 of on-coming traffic are detected within the ROI 31 or the safe zone 33 of the ROI 31 during the parking-out process, the vehicle 1 is maneuvered by the ECU 3 along the parking-out trajectory 29 into the adjoining roadway 15. Accordingly, the ECU 3 may control the steering, braking, and any gear changes required by the vehicle 1 to carry out the parking-out process along the parking-out trajectory 29. In the case that a traveling vehicle 21 of on-coming traffic along the adjoining roadway 15 has entered the safe zone 33 of an ROI 31 of the vehicle 1 while the vehicle 1 is performing a parking-out process, but the traveling vehicle 21 has not crossed a threshold 35 of the safe zone 33, the vehicle 1 continues the parking-out process along the parking-out trajectory 29 into the adjoining roadway 15.

As such, the method completes with the vehicle 1 fully exited from the previously occupied parking space 37 and thereby traveling along the adjoining roadway 15. However, in a case where a traveling vehicle 21 of on-coming traffic along the roadway 15 has crossed the threshold 35 of the safe zone 33 of the ROI 31 while a vehicle 1 is performing a parking-out process, the ECU 3 may determine the course of action based on a completion percentage of the parking-out process when the traveling vehicle 21 crossed the threshold 35 of the safe zone 33. If a completion percentage of the parking-out process of the vehicle 1 is greater than a predetermined completion percentage prior to a traveling vehicle 21 crossing the threshold 35 of the safe zone 33, the ECU 3 of the vehicle 1 may continue or pause the parking-out process. In particular, the ECU 3 may actuate the external and internal warnings of the vehicle 1 while continuing the parking-out process of the vehicle 1 at the same or a slower speed. Alternatively, the ECU 3 of the vehicle 1 may actuate the external and internal warnings of the vehicle 1 while pausing the parking-out process, thereby stopping the vehicle 1 at the current location of the vehicle 1 along the parking-out trajectory 29. The vehicle 1 may then wait for the traveling vehicle 21 to change lanes 19 of the roadway 15, to travel around the vehicle 1 along the roadway 15, or to also stop in the roadway 15. Subsequently, the vehicle 1 may resume the parking-out process into the roadway 15 adjoining the occupied parking space 37 occupied by the vehicle 1.

In the case where a completion percentage of the parking-out process of the vehicle 1 is less than a predetermined completion percentage subsequent to a traveling vehicle 21 crossing the threshold 35 of the safe zone 33, the ECU 3 of the vehicle 1 may abort the parking-out process. Specifically, the ECU 3 may control the vehicle 1 to pull back into the occupied parking space 37. In order to pull back into the occupied parking space 37, the ECU 3 may determine a parking-in trajectory 27 and perform a parking-in process. Subsequent to the vehicle 1 fully returning into the occupied parking space 37, the method may restart at step 1210.

Accordingly, embodiments disclosed herein relate to systems and methods useful for executing an autonomous parking process of a vehicle 1. The disclosed systems and methods advantageously execute parking-in processes and parking-out processes for automated and autonomous vehicles 1 depending on the movement of traveling vehicles 21 of on-coming traffic. This benefit, in turn, advantageously reduces the amount of time a vehicle 1 searches for an unoccupied parking spot during a parking-in process and waits in an occupied parking spot during a parking-out process.

Although only a few embodiments of the invention have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for executing an autonomous parking process of a vehicle using a driver assistance system, comprising:
sensing an external environment of the vehicle;
receiving coordinates identifying a location of the vehicle, and receiving a navigational speed limit that is associated with the location identified by the coordinates;
transmitting data associated with the external environment and the navigational speed limit to an Electronic Control Unit (ECU) of the vehicle;
carrying out the autonomous parking process of the vehicle;
determining a region of interest of the external environment of the vehicle based on the data and the navigational speed limit; and
monitoring on-coming traffic within the region of interest.

2. The method according to claim 1, wherein the monitoring on-coming traffic within the region of interest comprises determining a speed and a position of each traveling vehicle within the region of interest.

3. The method according to claim 1, wherein the autonomous parking process is a parking-in process for entering an unoccupied parking space or a parking-out process for exiting an occupied parking space occupied by the vehicle.

4. The method according to claim 3, further comprising:
identifying the unoccupied parking space; and
determining a parking-in trajectory for the vehicle into the unoccupied parking space based on a geometry of the unoccupied parking space and the location of the vehicle relative to the unoccupied parking space.

5. The method according to claim 3, further comprising determining a parking-out trajectory of the vehicle to exit the occupied parking space occupied by the vehicle based on a geometry of the occupied parking space and a geometry of a roadway connected to the occupied parking space.

6. The method according to claim 1, further comprising determining a safe zone of the region of interest.

7. The method according to claim 6, further comprising modifying the safe zone based on a speed and a position of a traveling vehicle of the on-coming traffic within the region of interest.

8. The method according to claim 6, further comprising aborting or pausing the autonomous parking process subsequent to the on-coming traffic entering the safe zone.

9. The method according to claim 6, further comprising continuing the autonomous parking process while the on-coming traffic is disposed within the safe zone if a completion percentage of the autonomous parking process is greater than a predetermined completion percentage.

10. A driver assistance system for a vehicle, comprising:
a plurality of detection sensors configured to collect data associated with an external environment of the vehicle;
a navigational sensor configured to receive coordinates identifying a location of the vehicle, and further configured to receive a navigational speed limit that is associated with the location identified by the coordinates; and
an Electronic Control Unit (ECU) configured to:
receive data associated with the external environment of the vehicle from the plurality of detection sensors;
receive the coordinates and the navigational speed limit from the navigational sensor;
carry out an autonomous parking process of the vehicle;
determine a region of interest of the external environment of the vehicle based on the data and the navigational speed limit; and
monitor on-coming traffic within the region of interest detected by the plurality of detection sensors.

11. The driver assistance system of claim 10, wherein at least one detection sensor of the plurality of detection sensors is an ultrasonic sensor.

12. The driver assistance system of claim 10, wherein at least one detection sensor of the plurality of detection sensors is a visual sensor configured to capture a video feed.

13. The driver assistance system of claim 10, wherein the ECU is further configured to determine an unoccupied parking space within the external environment of the vehicle based on the data provided by the plurality of detection sensors.

14. The driver assistance system of claim 10, wherein the ECU is further configured to determine a speed and a position of each traveling vehicle within the region of interest based on the data provided by the plurality of detection sensors.

15. The driver assistance system of claim 10, wherein the region of interest is disposed within a single lane of a multilane roadway.

16. The driver assistance system of claim 10, wherein the ECU is further configured to determine the region of interest based on an estimated time to complete the autonomous parking process.

17. The driver assistance system of claim 10, wherein the ECU is further configured to determine a safe zone of the region of interest, the safe zone being a predetermined percentage of the region of interest or a predetermined time for the on-coming traffic to be located within the region of interest.

18. The driver assistance system of claim 10, wherein the autonomous parking process is a parking-in process for entering an unoccupied parking space or a parking-out process for exiting an occupied parking space occupied by the vehicle.

19. The driver assistance system of claim 18, wherein the ECU is further configured to determine a parking-in trajectory for the vehicle into the unoccupied parking space based on a geometry of the unoccupied parking space measured by the plurality of detection sensors and the location of the vehicle relative to the unoccupied parking space.

20. The driver assistance system of claim 18, wherein the ECU is further configured to determine a parking-out trajectory of the vehicle to exit the occupied parking space occupied by the vehicle based on a geometry of the occupied parking space measured by the plurality of detection sensors and a geometry of a roadway connected to the occupied parking space.
